(19) United States
(12) Patent Application Publication
(10) Pub. No.: US 2013/0124548 A1
(43) Pub. Date: May 16, 2013

(54) System and Method for Presenting A Plurality of Email Threads for Review

(71) Applicants: Mahesh CHHAPARIA, Hyderabad (IN); Gaurav Agarwal, Balrampur (IN)

(72) Inventors: Mahesh CHHAPARIA, Hyderabad (IN); Gaurav Agarwal, Balrampur (IN)

(73) Assignee: Google Inc., Mountain View, CA (US)

(21) Appl. No.: 13/599,728

(22) Filed: Aug. 30, 2012

(30) Foreign Application Priority Data
Aug. 30, 2011 (IN) 2995/CHE/2011

(51) Int. Cl. G06F 17/30

(52) U.S. Cl. CPC G06F 17/30424
USPC 707/758

(57) ABSTRACT

In an embodiment, characteristics of an email thread are analyzed to find related email threads. Email threads are combined to identify duplicate emails and to generate a superset thread, which maintains the context of combined email threads. The superset thread is displayed to a reviewer for review, wherein each unique email is displayed only once. In an embodiment, a system for presenting a plurality of email threads includes a thread analyzer, a database manager, and a superset thread generator. The thread analyzer analyzes characteristics of an email thread. The database manager indexes and identifies email threads from networked databases. The superset thread generator combines the email threads to determine duplicate emails and generates a superset thread, which maintains the context of each of the combined email thread.

### CROSS-REFERENCE TO RELATED APPLICATIONS

This application claims priority to Indian Provisional Application No. 2995/CHE/2011, filed Aug. 30, 2011, which is incorporated by reference herein in its entirety.

### FIELD

Embodiments relate generally to electronic mail systems, and more particularly, to presenting a plurality of email threads for review.

### BACKGROUND

Document review is a critical component to most litigations. In response to a discovery request, document review is used to identify responsive and privileged documents to produce or withhold, and allows the legal team to gain a greater understanding of the factual issues in a case. Accordingly, the document review stage of a litigation is the time when the legal team begins to formulate legal strategies based on the information found in the collection of documents.

Historically, attorneys would review every document presented to them by the client or opposing counsel in the litigation for relevance, responsiveness to discovery requests, and privilege. However, companies now have enormous quantities of electronically stored information (“ESI”) that may be subject to discovery in a legal dispute. With the explosion of email and other electronic documents, reviewing each and every document is often a time consuming and costly endeavor.

### BRIEF SUMMARY

Embodiments relate to presenting a plurality of email threads for review. In an embodiment, characteristics of an initial email thread are analyzed to identify other related email threads. The initial email thread and the related email threads are combined to generate a superset thread, wherein the initial email thread and the related email threads are arranged to maintain a context of mails contained in the superset thread. The superset thread is displayed to a reviewer for review, such that any duplicate emails are displayed only once.

In an embodiment, characteristics of an email thread containing a subset of emails are analyzed to identify one or more related email threads, each containing a respective subset of emails. The subsets of emails are combined to generate a union set of emails, wherein the union set of emails contains only a single instance of each duplicate email in the subsets of emails. A superset thread is generated from the union set of emails, wherein each email in the superset thread is arranged to maintain a context in relation to each other email in the superset thread. The superset thread is displayed to a reviewer for review.

In an embodiment, a system for presenting a plurality of email threads includes a thread analyzer, a database manager, and a superset thread generator. The thread analyzer analyzes characteristics of a given email thread to identify related email threads. The database manager indexes and identifies emails and email threads from networked databases. The superset thread generator combines the email threads to identify duplicate emails and generate a superset thread, which maintains a context of each combined email thread in relation to each other combined email thread.

Further embodiments, features, and advantages of the invention, as well as the structure and operation of the various embodiments of the invention are described in detail below with reference to accompanying drawings.

### BRIEF DESCRIPTION OF THE DRAWINGS/FIGURES

Embodiments are described with reference to the accompanying drawings. In the drawings, like reference numbers may indicate identical or functionally similar elements. The drawing in which an element first appears is generally indicated by the left most digit in the corresponding reference number.

FIG. 1 is a flowchart of an exemplary method for displaying a plurality of email threads, according to an embodiment.

FIG. 2 is a block diagram of an exemplary email processing system for presenting a plurality of email threads to a reviewer for review, according to an embodiment,

FIG. 3 is a block diagram of another exemplary email processing system for presenting a plurality of email threads to a reviewer for review, according to an embodiment.

FIG. 4 is an illustration of an exemplary networked database and index structure, according to an embodiment.

FIG. 5 is a flowchart of an exemplary method for presenting a plurality of email threads to a reviewer for review, according to an embodiment.

FIG. 6 is a flowchart of an exemplary method for analyzing characteristics of an email contained in an email thread, according to an embodiment.

FIG. 7A is an illustration of exemplary email threads contained in multiple email accounts.

FIG. 7B is an illustration of an exemplary superset thread generated by superset thread generator, according to an embodiment.

FIG. 8 is a block diagram illustrating an exemplary computer system that may be implemented as computer-readable code, according to an embodiment of the present invention.

### DETAILED DESCRIPTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

### Overview

The terms “thread” and “email thread” are used interchangeably in this document to refer broadly and inclusively to any series of related emails, as would be apparent to a person skilled in the art given this description. For example, an email thread may contain a single email that is not a reply to an earlier email, or it may contain multiple related emails. Embodiments as described herein may be used in many thread-based email services.

Email has become a common tool in both business and personal communication. A typical email communication between two individuals creates an email thread containing a chain of replies. Some email thread systems may create multiple instances of the same email in each individual's email account. Additional email threads containing similar, but not identical, sets of emails may be created if an email is sent to multiple recipients or forwarded to a third person. Email threads may become lengthy and complex as the number of individuals involved in the email communication increases.

Using conventional document review systems, reviewers may waste significant amounts of time reading the same email multiple times, which translates into a significant waste of a litigant's resources. Additionally, reviewing each email thread separately makes it more difficult for reviewers to fully understand the context of emails, which degrades the accuracy and overall quality of the review.

In embodiments, a plurality of email threads is combined to generate a superset thread, and is presented as a hierarchical thread tree without duplicate emails that existed in the email threads. Also, the context of each email in the superset thread is maintained as all emails are chronologically ordered and email progressions (e.g., replies and forwards) are shown as branches of the superset thread tree. Review time is saved, because reviewers do not need to read duplicate emails multiple times. Also, review quality is increased, because the thread tree helps the reviewer to follow the conversations and understand the context of each email contained in the thread tree.

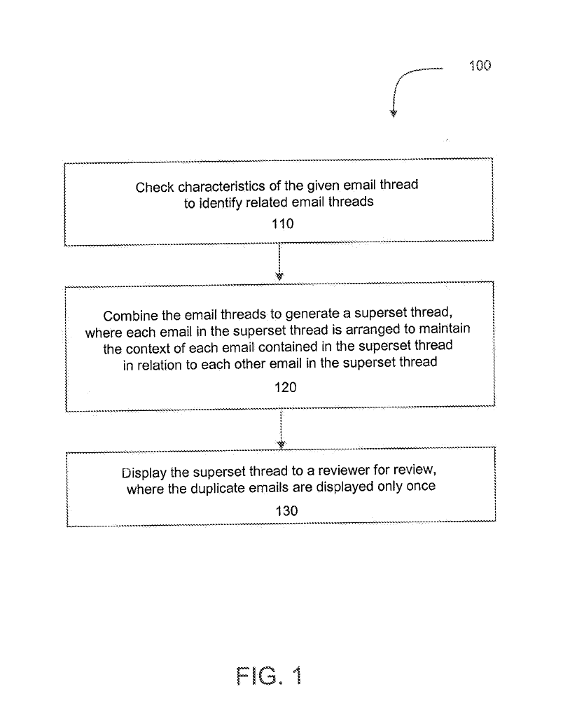

FIG. 1 illustrates a method for presenting a plurality of email threads for review, according to an embodiment. Such a method may be implemented by, for example, an email processing server application that provides email services to users (such an email application typically runs on a server often referred to as a “mail server”), and/or a review client application (“review client”) through which a reviewer interfaces with the email processing server application.

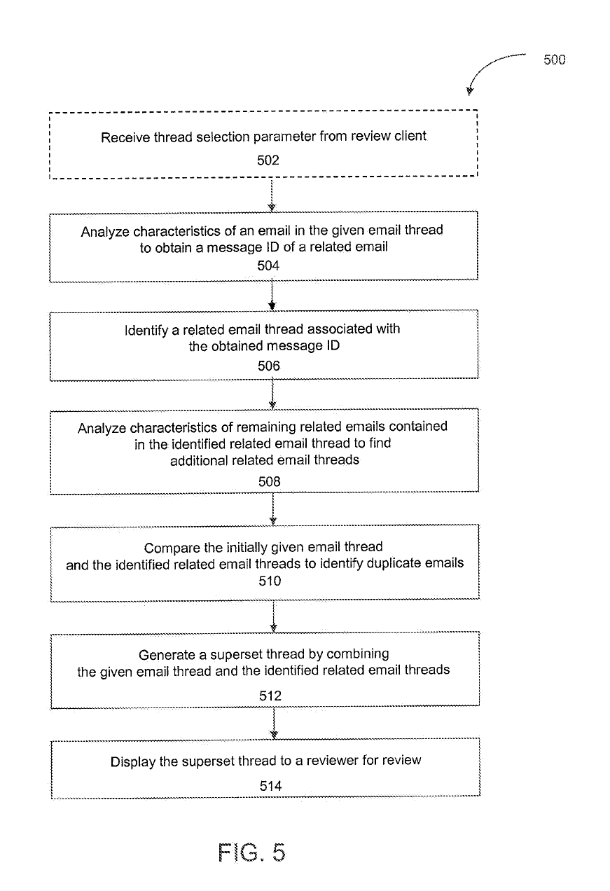

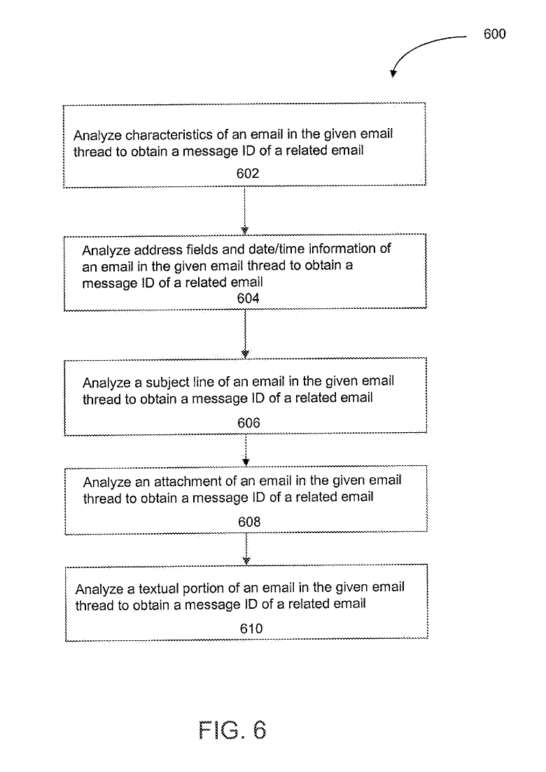

The method illustrated in FIG. 1 includes analyzing characteristics of a given email thread to identify other related email threads in the a defined email corpus (such as an entire accessible email corpus) (stage 110), which is further described below with respect to FIGS. 5 and 6. The method also includes combining the identified related email threads with the given email thread to generate a superset thread, where each email in the superset thread is arranged to maintain the context in relation to each other email in the superset thread (stage 120). The method further includes displaying the generated superset thread to a reviewer for review, where the duplicate emails in the superset thread are displayed only once (stage 130).

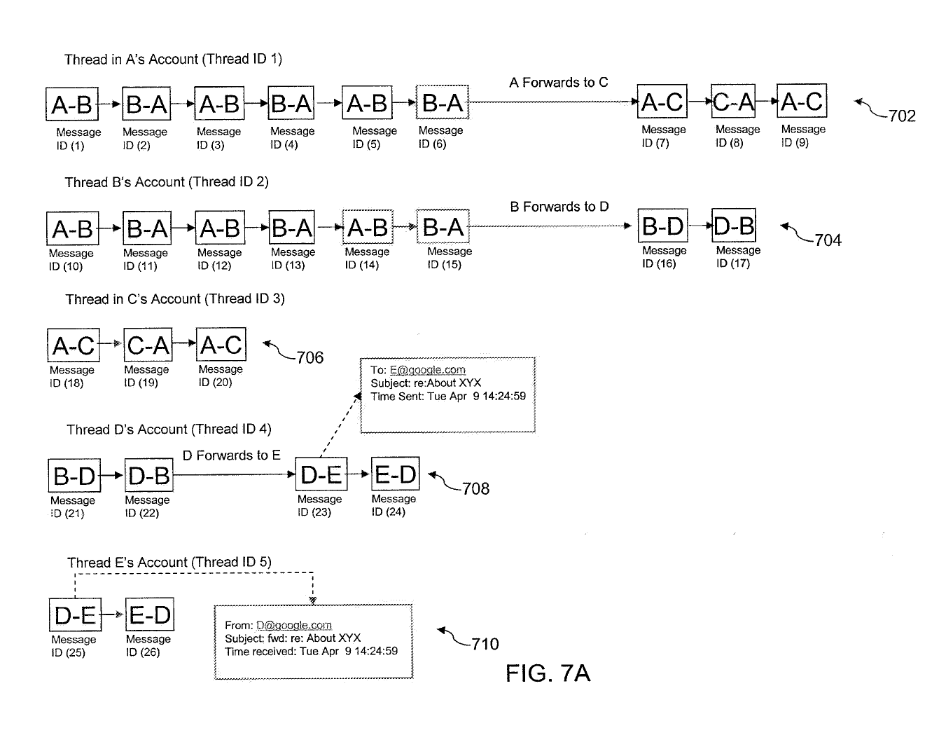

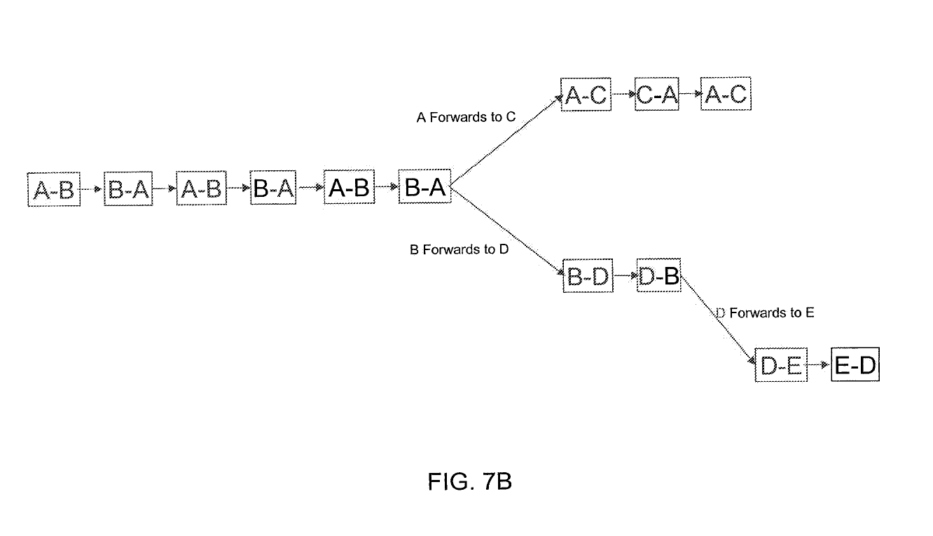

Attention is now directed to FIG. 7A, which illustrates an example of redundant email threads in an exemplary email corpus. When a first email user, referred to herein as user A, sends an email to a second email user, referred to herein as user B, an identical email thread is created in each of the user's email account. For example, in FIG. 7A, thread 702 is created in user A's email account and thread 704 is created in user B's email account. An additional chain of replies between user A and user B add more emails to thread 702 and thread 704. As shown in FIG. 7A, six emails (message if) #1-#6), representing email communications between user A and user B, are contained in thread 702. Likewise, six emails (message ID #10-#15), representing the same email communications between user A and user B, are also contained in thread 704. Note that each of the thread in user A's email account and the thread in user B's email account has a distinct thread ID. Also, each email communication between use' A and user B has a distinct message ID even though the content of each respective email is the same. For example, message ID #1 and message ID #10 are identical email that user A sent to user B at certain time.

Although thread 702 and thread 704 were once identical, each of the threads evolved differently when user A forwarded an email to a third person, referred to herein as user C, and when user B forwarded an email to a fourth person, referred to herein as user D. When user A forwarded an email to user C, thread 706 was created in user C's email account. Additional chain of replies between user A and user C added more emails to thread 702 and thread 706. As shown in FIG. 7A, thread 706 contains a total of three emails (message ID #18-#20), and the three identical emails (message ID #7-#9) are added to thread 702.

Similarly, thread 708 was created in user D's email account when user B forwarded an email to user D. A reply from user D to user B added one more email to thread 704 and thread 708. Yet another thread (thread 710) was created in a fifth person's (referred to herein as user E) email account when user D forwarded an email to user E. A reply from user E to user D added an additional email to thread 708 and thread 710.

As shown in FIG. 7A, thread 704 contains total of eight emails (message ID #10-#17), in which two emails (message ID #16, #17) represent email communications between users B and D. Thread 708 in user D's email account contains a total of four emails, in which two emails (message ID #21, #22) represent the email communications between user B and D that are identical to message ID #16 and #17 contained in thread #2. Two other emails in thread 708 (message ID #23, #24) represent email communications between users D and E that are identical to two emails (message ID #25, #26) of thread 710 in user E's email account. Note that threads 706, 708, and 710 do not contain emails that represent email communications between users A and B even though threads 706, 708, and 710 originate from the email communication between users A and B. Also, threads 706 and 710 do not contain duplicate emails among them even though threads 706 and 710 relate to each other as they both stem from identical emails (messages #6 and #15 which are duplicate).

For the five threads shown in FIG. 7A, a conventional document review system may create, for instance, a total of five documents, each representing each of the five email threads. Some document review systems may even create a total of 26 documents, each representing each of the emails shown in FIG. 7A. Moreover, many conventional document review systems create a separate document for each email progression. For example, one document may contain message ID #1 and #2, and the next document may contain message ID #1 through #3. In such case, a reviewer would have read the very first email (message ID #1 and #10) for a total of 17 times by the end of the review.

A number of emails that needs to be reviewed in a typical litigation involving a large publicly traded company is usually very high. Therefore, the inefficiency caused by reviewing the same emails multiple times can have a dramatic impact on the cost and time of the litigation Some document review systems have attempted to provide duplicate and near-duplicate documents identification functions to minimize reviewing duplicate emails multiple times. Nevertheless, existing document review systems require emails to be culled from archives and be processed as documents before the document review systems try to find duplicate documents. Indeed, so called duplicate document identification functions merely compare the documents after each email, email progression, or thread is processed as a separate document. Therefore, existing document review systems do not meat two versions of the same email as duplicate.

Under the conventional approach, none of the five email threads shown in FIG. 7A are identified as duplicate documents because each contains a different email thread, with a different set of emails. Even in a situation where each thread is processed based on each email progression, for example, one document containing messages #1-#6 and another document containing messages #1-#7, these two documents are not identified as duplicate documents. A conventional near-duplicate identification function searches for similar text or other attributes after the underlying content (e.g., email thread) is processed as a document. By definition, the near-duplicate documents are not identical, and thus, reviewers still have to review each and every near-duplicate document.

Attention is now directed to FIG. 7B, which shows an example of a superset thread generated by an embodiment. The superset thread shown in FIG. 7B is illustrative and not intended to limit the embodiments to this specific example or its features. In this example, the five related email threads shown in FIG. 7A are combined to generate a superset thread and are presented as a hierarchical email tree without duplicate emails. A context of each email in the superset thread is maintained, as all emails are chronologically ordered while each email progressions are shown as branches of the superset thread. Reviewing a superset thread speeds the review process by enabling reviewers to review all related emails at once. In addition, reviewing a superset thread increases the review quality by helping reviewers to understand the context of emails in the related email threads. In the example above, a reviewer can review all five email threads by reviewing just one superset thread. Such improvements have a direct impact on the overall cost of review by reducing the number of hours expensed by reviewers.

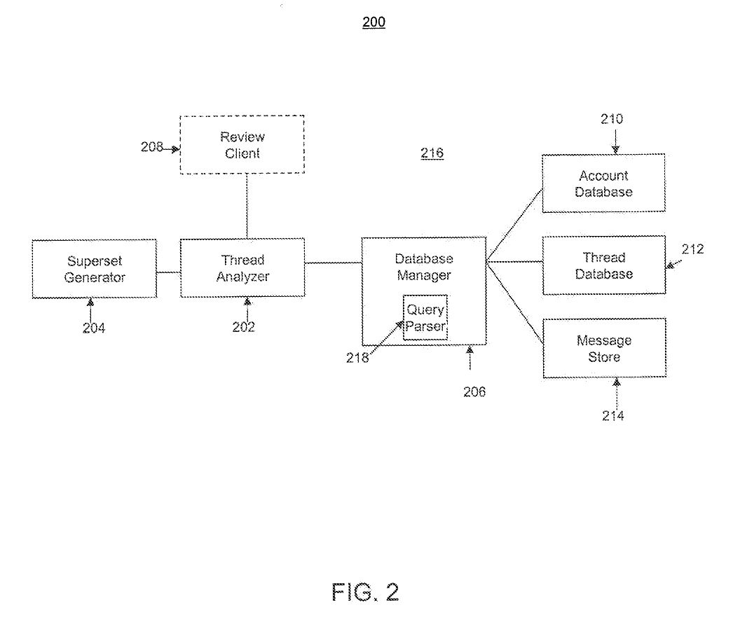

Attention is now directed to FIG. 2, which is a block diagram of an email processing system 200 for presenting a plurality of email threads for review, according to an embodiment. As shown in FIG. 2, email processing system 200 may include a thread analyzer 202, a superset thread generator 204, and a database manager 206. Email processing system 200 may utilize various other networked components to process a variety of requests from a review client 208. As will be described in further detail below, email processing system 200 may be coupled to various databases such as an account database 210, a thread database 212, and a message store 214. Each of these couplings may exist as a direct connection or may exist as an indirect connection through network 216.

Network 216 can be any network or combination of networks that can carry data communications, and may be referred to herein as a computer network. Such network 216 can include, but is not limited to, a local area network, medium area network, and/or wide area network such as the Internet. Network 216 can support protocols and technology including, but not limited to, World Wide Web protocols and/or services. Intermediate web servers, gateways, or other servers may be provided between components of email processing system 200 depending upon a particular application or environment.

Review client 208 can be implemented in software, firmware, hardware, or any combination thereof. Review client 208 can be implemented to run on any type of processing device including, but not limited to, a computer, workstation, distributed computing system, embedded system, stand-alone electronic device, networked device, mobile device, or other type of processor or computer system. Such a processing device implementing a review client 208 may be referred to herein as a remote client device.

Likewise, email processing system 200 can be implemented in software, firmware, hardware, or any combination thereof Email processing system 200 can be implemented to run on any type of processing device including, but not limited to, a computer, workstation, distributed computing system, embedded system, stand-alone electronic device, networked device, mobile device, or other type of processor or computer system.

Email processing system 200 can be used as a stand-alone system or in connection with a search engine, web portal, web site, or any other application configured to present a plurality of email threads for review. Email processing system 200 can operate alone or in tandem with other servers, web servers, or devices, and can be part of any application, search engine, portal, or web site.

Functionality described herein is described with respect to components for clarity. However, this is not intended to be limiting, as functionality can be implemented on one or more components on one device or distributed across multiple devices.

### Database Manager

In an embodiment, database manager 206 handles a set of routines for indexing, identifying, storing, and retrieving information from networked databases (e.g., an account database 210, a thread database 212, a message store 214). Database manager 206 also manages overall communication in email processing system 200, including between account database 210, thread database 212, and message store 214.

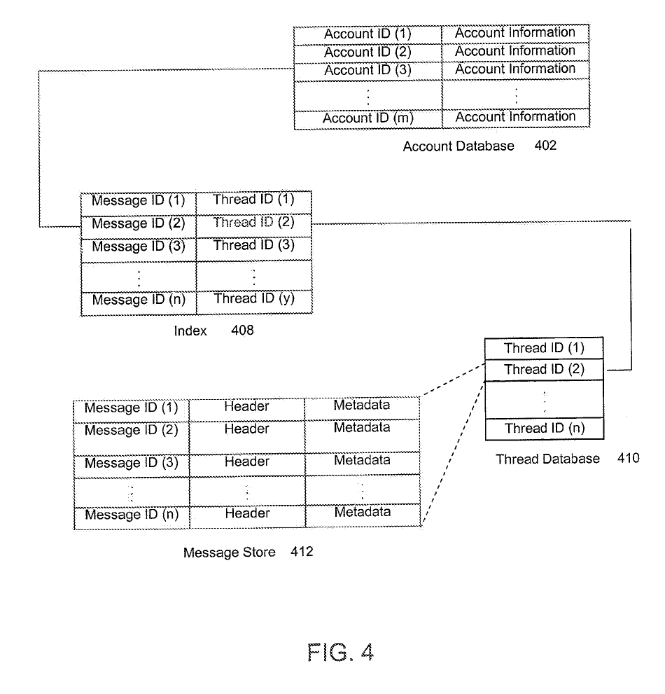

Attention is now directed to FIG. 4, which illustrates an exemplary database structure used in one embodiment. Account database 402 may contain a list of account IDs and information about each account's mailbox that is used to generate a view of the email user's mailbox. The information in account database 402 may include, for example and without limitation, an index 408, which lists thread entries of an email user's mailbox with a reference to the actual storage location of the email instances in message store 412. Account database 402 may also include mutable information about the contents, for example and without limitation, priority metadata and/or tag metadata.

As shown in FIG. 4, thread database 410 may include a number of email thread entries. Each email thread entry may be associated with a distinct thread ID, and each thread entry may contain a list of emails associated with the thread ID. In an embodiment, each and every email thread in each email account may have a distinct thread ID. Each and every email instance may also have a distinct message ID. Since each message ID is associated with a particular thread ID, a message ID may be used to identify an email thread containing the email with a specific message ID. Once an email thread is identified, remaining emails contained in the identified email thread may be found.

Message store 412 stores the actual email instances including any attachments embedded within email instances. Message store 412 may perform a variety of other operations, for example and without limitation, arranging, sorting, indexing, and clustering, emails based on the attributes of emails. The various attributes of an email may include, for example and without limitation, contents of an email, attachment information of an email, header information of an email, and/or any other metadata associated with an email.

Now referring back to FIG. 2, the functionality of database manager 206, account database 210, thread database 212, and message store 214, or any combinations thereof, may be combined into one component, in an embodiment. For instance, database manager 206, as a single component, may contain email thread indexes and email instance indexes as well email user account information. One of skill in the art will recognize, however, that the functionality may also be distributed across multiple components.

In operation, according to an embodiment, review client 208 requests to operate on a certain email thread, and database manager 206 identifies an initial email thread from thread database 212 to begin analysis. In an embodiment, review client 208 may specify a thread ID. Database manager 206 may use the specified thread ID to identify the initial email thread from thread database 212. In an embodiment, review client 206 may specify a message ID. In such case, database manager 206 may identify a thread containing an email associated with the specified message ID.

In an embodiment, database manager 206 may include a query parser 218 to handle a variety of more complex parameters received from review client 208. The parameters may include, for example and without limitation, an account ID, a message ID, a thread ID, a minimum/maximum number of emails in a thread, date range value, header information (e.g., sender/recipient information, date/time information, subject line information) of an email initiating an email thread, a list of custodians, and/or a list of accounts. One of skill in the art will recognize that the parameters may also include a variety of other attributes and data not listed above.

Database manager 206 may also receive parameters from thread analyzer 202. As will be discussed later, thread analyzer 202 analyzes characteristics of an email or a thread, and obtains information that may be used by database manager 206 to identify additional related emails and/or email threads. Additional parameters from thread analyzer 202 may include, but are not limited to, an account ID, a message ID, a thread ID, header information of an email, address fields of an email, metadata of an email, representative subject line of an email thread, normalized subject line of an email, normalized date/time information, attachment information, textual portion of an email, and/or hash value for textual portion of an email. Those skilled in the art will appreciate that parameters from thread analyzer 202 may include additional attributes or values not listed above.

### Thread Analyzer

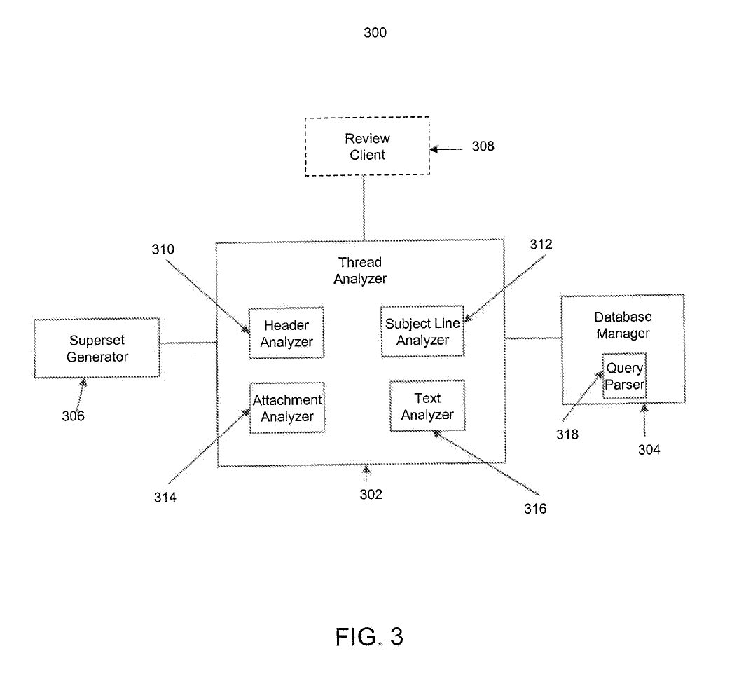

Attention is now directed to FIG. 3, which shows thread analyzer 302 according to an embodiment. Thread analyzer 302 analyzes characteristics of a given email or email thread to identify other related email threads in a defined email corpus (such as the entire accessible email corpus). In an embodiment, thread analyzer 302 obtains message IDs of related emails from the header information of emails contained in the given email thread. Header information may contain information which may provide message IDs of related mails, for example and without limitation, “In-Reply-To” and/or “References” fields. For instance, an “In-Reply-To” field of an email generally contains a message ID of the parent email. In addition, a “References” field generally contains a list of message IDs associated with the previous emails in the email thread. Generally, the last message ID in the “References” field identifies the parent email, and the first message ID in the “References” field identifies the first email in the same email thread. These message IDs may be obtained by thread analyzer 302 and sent to database manager 304 to identify email threads containing emails with the obtained message IDs.

However, “In-Reply-To” and “Reference” fields in header information may be optional for some email clients, and hence, some email instances may not contain this information in the header. In addition, some email instances may be in a different email system using a different database or index structure. In these situations, thread analyzer 302 may utilize other characteristics of the given email threads.

Accordingly, in an embodiment, thread analyzer 302 may include a header analyzer 310 that analyzes address fields and date/time information of each email in the given email thread. Address fields may include, for example, from, to, cc, and bcc fields. Date/time information may include, for example, a sent/received timestamp. Email accounts (e.g., mailboxes) that may contain related emails can be identified by analyzing the address fields of an email in the given email thread. An identified email account can be searched for emails with corresponding address fields and date/time information. For example, the “to” field and “sent” timestamp information may be used as a query to find an email instance with a corresponding “from” field and “received” timestamp information.

Due to the vagaries of modern networking, two identical email instances (e.g., the sent message and its corresponding received message) do not always have the same timestamp. Therefore, a predetermined time compensation value can be specified to account for date/time information differences between compared emails. In addition, date/time information of each email may need to be normalized to account for the time zone difference. An email thread can be reassembled from a set of emails found in the identified email account using a conventional email thread reassembly technique.

In an embodiment, thread analyzer 302 may include a subject line analyzer 312 that normalizes subject lines (e.g., removes “re:”, “fw:”, “fwd:” prefixes) of emails in a given email thread, and obtains a nontrivial representative subject line of the given email thread. In an embodiment, the identified email account can be searched for emails having the identified representative subject line.

In an embodiment, thread analyzer 302 may include an attachment analyzer 314 that analyzes characteristics of attachments attached in emails of a given email thread. Characteristics of attachments may include, but are not limited to, file size, file name, and/or metadata associated with the attachment file. The identified email account can be searched for email instances containing an attachment with the matching characteristics.

In an embodiment, thread analyzer 302 may include a text analyzer 316 that analyzes and compares textual portions of emails. For example, a text body of an email can be used as a query and the query may run against emails in a targeted email account to find an email containing the same text in the body or in the delineated (e.g., quoted) portion of the email. This comparison may be performed using various methods including, for example and without limitation, character-by-character comparison, word-by-word comparison, hash value comparison, and/or checksum value comparison. One skilled in the art will recognize from this detailed description that text comparison may be performed in many different ways.

In an embodiment, a quoted portion of an email may contain additional header information from the preceding email, such as address information, subject line, and/or date/time information. This additional information can be extracted and analyzed further to identify additional email accounts which may contain additional related emails.

### Superset Thread Generator

As shown in FIG. 3, an embodiment includes a superset thread generator 306. Superset thread generator 306 combines a plurality of related email threads to generate a superset thread containing related emails stemming from the same original email. In one example, as illustrated in FIG. 7B, a superset thread may be in the shape of a thread tree showing email progressions (e.g., forwards and replies) as branches of the thread tree so that context is given to all of the emails.

Superset thread generator 306 may arrange related email threads so that a context of each related email thread is maintained in relation to other related email threads. In an embodiment, superset thread generator 306 may identify duplicate emails by comparing emails in one email thread to emails in other related email threads. For example, superset thread generator 306 may compare header information of emails to identify duplicate emails. Header information used in identifying duplicate emails may include, but is not limited to, message ID, thread ID, “In-Reply-To” field, “Reference” field, address fields, subject line field, and/or date/time stamp. Superset thread generator 306 may also compare textual portions of emails in one email thread to emails of other related email threads to identify duplicate emails.

In an embodiment of superset thread generator 306, duplicate emails may be included in the superset thread, but suppressed and hidden from view when displaying the superset thread to a reviewer. For example, superset thread generator 306 may combine related email threads by arranging duplicate emails in one email thread to overlap the same duplicate emails contained in the other related email threads so that overlapping duplicate emails are shown only once in the superset thread.

In an embodiment of superset thread generator 306, duplicate emails may be removed from the threads before combining the threads to generate a superset thread. Once duplicate emails are removed from each of the related email threads, superset thread generator 306 may use header information of emails in each of the related email threads to find an ideal connection point (e.g., node of the superset thread tree). Header information used in identifying the ideal connection point may include, but is not limited to, an account ID, a message ID, a thread ID, “In-Reply-To” field, “Reference” field, address fields, a subject line field, and/or date/time stamp. For example, superset thread generator 302 may analyze “In-Reply-To” and “References” information of initial emails in each of the related email threads to obtain message IDs of parent emails, which may be the ideal connection points in the superset thread. In case where a message ID of the parent email cannot be obtained from “In-Reply-To” or “References” fields, address fields and date/time information of initial emails in each of the related email threads may be used to find an ideal connection point in the superset thread.

### Methods

Embodiments of the operation of email processing system 300 are further described with respect to methods 500 and 600 in FIGS. 5 and 6. Methods 500 and 600 will be described with reference to email processing system 300 but are not necessarily limited to the structure of email processing system 300.

FIG. 5 illustrates an exemplary routine 500 for displaying a plurality of email threads to a reviewer for review, according to an embodiment. Step 502 is an optional step. In step 502, one or more email thread selection parameters may be received from a review client, such as review client 308. The thread selection parameter may be used to select an initial email thread to begin analysis. Alternatively, the thread selection parameter may be used as a query during identification of related emails and email threads. As discussed above, thread selection parameters may include, but are not limited to, an account ID, a message ID, a thread ID, a list of email addresses, a list of identified custodians, a date range, a minimum/maximum number of email instances in the email thread, and/or an identifier for specifying a litigation matter. The thread selection parameters may be received by, for example, database manager 304.

In operation, for example, a constrained set of custodians and an identifier for specifying a litigation matter (e.g., litigation ID) can be specified by a reviewer. An appropriate query tree may be created from the thread selection parameter by, for example, query parser 318. The query may run against the set of identified custodians for the specified litigation matter and identify related email threads that match the query. One of skilled in the art will recognize from this detailed description that a reviewer may customize the query in various ways.

In stage 504, characteristics of a given email thread are analyzed to obtain a message ID of an email that relates to the given email thread. The characteristics of the given email thread may be analyzed by, for example, thread analyzer 302. The characteristics of an email thread may include information regarding each email contained in the email thread. As discussed above, information regarding an email may include, for example and without limitation, header information, metadata, a normalized subject line, normalized date/time information, attachment information, a textual portion, and/or a hash value for textual portion. The characteristics of an email may be analyzed in various ways.

FIG. 6 illustrates an exemplary method 600 for analyzing characteristics of an email contained in the given email thread, according to an embodiment. In stage 602, header information of an email in the given email thread is analyzed to obtain a message ID of a related email. A message ID of an email may be obtained from attributes, metadata, and/or header information. As discussed above, one way of obtaining a message ID of a related email is by analyzing “In-Reply-To” and “References” fields of an email. A message ID of the related email may be associated with a particular thread ID. Once this related email thread containing the related email is identified, remaining emails in the identified email thread are also identified. Each of the newly identified related emails may be analyzed until no additional related email threads are identified within a defined email corpus (e.g., the entire accessible email corpus). As described above, database manager 304 may be used to identify the remainder of emails included in the related email threads.

In stage 604, additional information in the header, such as address fields and date/time information, is also analyzed to identify related emails and threads. Using the address fields of an email, an email account that contains a related email thread is identified. The identified email account is searched for related email instances. For example, the “to” field and “sent” timestamp information can be used as a query to find an email instance with a corresponding “from” field and “received” timestamp information. As discussed above, date and timestamp information may need to be normalized to account for any time zone difference between the sender and recipient. In addition, a predetermined time compensation value may be used to account for possible time stamp differences caused by network delays. Header information of emails may be analyzed by, for example, header analyzer 310.

In stage 606, the subject line of the email is normalized by removing prefixes (e.g., “re”, “fw”, “fwd”), and the identified email account is searched for emails containing the same normalized subject line. The subject line of an email may be normalized and analyzed by, for example, subject line analyzer 312. In stage 608, an attachment of an email is analyzed to identify related emails and related email threads. For example, an attachment's file name and file size are obtained, and the identified email account is searched for other email instances having the same attachment. Attachments of emails may be analyzed by, for example, attachment analyzer 314.

In stage 610, a textual portion of the email is analyzed to identify related emails and related email threads. For instance, the text body of an email is used as a query, and the query is run against emails contained in the identified email account to find emails containing the same text in its body or in a quoted portion. The text comparison may be carried out by, for example, text analyzer 316. As discussed above, a quoted portion of an email may contain address information, subject line, and/or date/time information. Such additional information may be extracted and analyzed further to identify additional email accounts which may contain additional related emails.

FIG. 6 thereby illustrates an exemplary method for analyzing characteristics of emails in a given email thread to identify other related email threads, according to an embodiment. Returning to FIG. 5, method 500 proceeds to stage 506.

In stage 506, a related email thread containing the email associated with the obtained message ID may be identified. As described above, a particular message ID may be associated with a particular thread ID. Once the related email thread is identified, a remainder of emails in that thread can be identified. In stage 508, the remainder of emails in the identified related email thread are analyzed with respect to additional related email threads until no additional email threads are found in the defined email corpus. As described above, database manager 304 may be used to identify the remainder of the email instances included in the related email threads.

In stage 510, the initially given email thread and the identified related email threads are compared against each other to identify duplicate emails contained in the threads. Comparing the email threads may occur in various ways. For example, address fields, date/time stamp, a subject line, an attachment, and/or textual portion of each email in one email thread may be compared with emails in another email thread to determine duplicate emails in the email threads. Comparing the email threads may be carried out by, for example, superset thread generator 306. Alternatively, comparing the email threads and finding duplicate emails may be carried out by, for example, thread analyzer 302, while thread analyzer 302 analyzes the characteristics of emails. Duplicate emails may also be identified by database manager 304 when database manager 304 runs queries to identify emails in the networked databases. It will be appreciated by those skilled in the art that identifying duplicate emails may be performed by hardware, software, or a combination thereof, as may be embodied in one or more computing systems such as a client system, a server system, or a database.

In stage 512, the initially given email thread and the identified related email threads are combined to generate a superset thread. The related email threads are arranged to maintain a context of each email contained in the superset thread. In an embodiment, as shown in FIG. 7B, the superset thread may be in the shape of a thread tree showing email progressions as branches of the superset thread tree so that the context of each email in the thread tree is maintained. The superset thread tree shown in FIG. 7B is generated by combining the five related email threads shown in FIG. 7A. In an embodiment, duplicate emails in the superset thread may be suppressed and hidden from view when displaying the superset thread to a reviewer.

With respect to maintaining the context of each email in the superset thread, characteristics of the earliest email in each related email thread may be analyzed to find an ideal connection point in a thread (e.g., a point which an email was forwarded) or node of the superset thread tree. In an example shown in FIG. 7A, characteristics of message ID #18 may be analyzed to identify that message ID #7 is a duplicate email. Therefore, message ID #6, which is the parent email of message ID #7 may be the ideal connection point. In an embodiment, all of the emails in the initially given email thread and the identified related email threads may be pooled to a single set. Then, each email in the set may be reassembled to generate a superset thread while leaving only a single instance of each unique email found in the set.

In stage 514, the superset thread is returned to the review client and displayed to a reviewer. In an embodiment, the reviewer can view a particular message by selecting that message in the superset thread.

The scope of data potentially subject to disclosure may be uncertain in the early phases of a litigation. The nature of the litigation itself and the individuals involved may change as the litigation progresses. As the litigation matter progresses, the legal team may identify more custodians or an additional corpus of emails. Exemplary embodiments of the present invention allow such changes to be managed efficiently. After new custodians or additional accessible emails are identified, a refresh option may be presented to a reviewer so that new version of a superset thread may be generated and presented. Reviewers may add annotations on each superset thread, each email thread, and each individual email. Reviewers may also create and apply descriptive labels, so that they can later view a list of superset threads by querying on the labels. Embodiments and implementations of methods of the present invention do not require emails to be copied a central archive to be processed, although embodiments are not limited to this implementation.

Embodiments shown in FIGS. 1-7, or any part(s) or function(s) thereof, may be implemented using hardware, software modules, firmware, tangible computer readable storage media having instructions stored thereon, or a combination thereof and may be implemented in one or more computer systems or other processing systems.

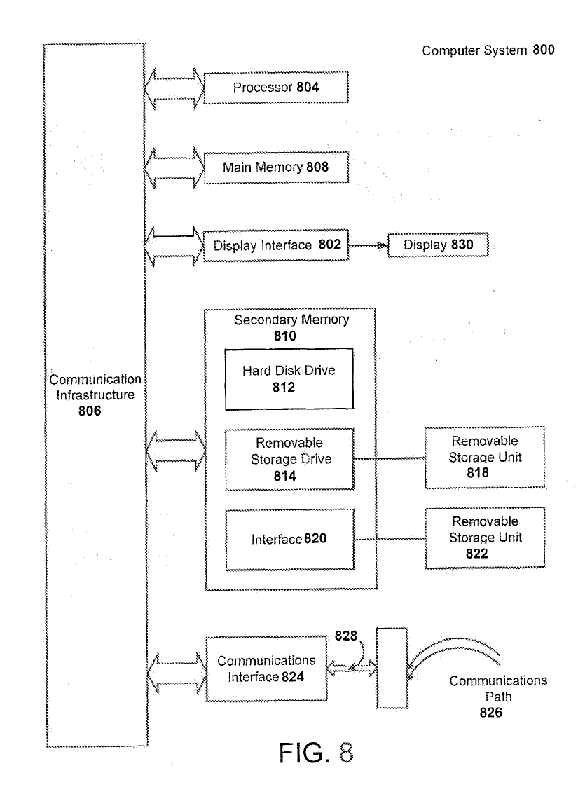

FIG. 8 illustrates an example computer system 800 in which embodiments, or portions thereof, may be implemented as computer-readable code. For example, email processing systems 200 and 300 in FIGS. 2 and 3 can be implemented in computer system 800 using hardware, software, firmware, tangible computer readable storage media having instructions stored thereon, or a combination thereof and may be implemented in one or more computer systems or other processing systems. Hardware, software, or any combination of such may embody any of the modules and components in FIGS. 1-7.

If programmable logic is used, such logic may execute on a commercially available processing platform or a special purpose device. One of ordinary skill in the art will appreciate that embodiments can be practiced with various computer system configurations, including multi-core multiprocessor systems, minicomputers, mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 800. After reading this description, it will become apparent to a person skilled in the relevant art how to implement embodiments of the present invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. As will be appreciated by persons skilled in the relevant art, processor device 804 may also be a single processor in a multi-core/multiprocessor system, such system operating alone, or in a cluster of computing devices operating in a cluster or server farm. Processor device 804 is connected to a communication infrastructure 806, for example, a bus, message queue, network, or multi-core message-passing scheme.

Computer system 800 also includes a main memory 808, for example, random access memory (RAM), and may also include a secondary memory 810. Secondary memory 810 may include, for example, a hard disk drive 812, removable storage drive 814. Removable storage drive 814 may comprise a floppy disk drive, a magnetic tape drive, an optical disk drive, a flash memory, or the like. The removable storage drive 814 reads from and/or writes to a removable storage unit 818 in a well known manner. Removable storage unit 818 may comprise a floppy disk, magnetic tape, optical disk, etc. which is read by and written to by removable storage drive 814. As will be appreciated by persons skilled in the relevant art, removable storage unit 818 includes a computer usable storage medium having stored therein computer software and/or data.

In alternative implementations, secondary memory 810 may include other similar means for allowing computer programs or other instructions to be loaded into computer system 800. Such means may include, for example, a removable storage unit 822 and an interface 820. Examples of such means may include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to computer system 800.

Computer system 800 may also include a communications interface 824. Communications interface 824 allows software and data to be transferred between computer system 800 and external devices. Communications interface 824 may include a modem, a network interface (such as an Ethernet card), a communications port, a PCMCIA slot and card, or the like. Software and data transferred via communications interface 824 may be in the form of signals, which may be electronic, electromagnetic, optical, or other signals capable of being received by communications interface 824. These signals may be provided to communications interface 824 via a communications path 826. Communications path 826 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 818, removable storage unit 822, and a hard disk installed in hard disk drive 812. Computer program medium and computer usable medium may also refer to memories, such as main memory 808 and secondary memory 810, which may be memory semiconductors (e.g. DRAMs, etc.).

Computer programs (also called computer control logic) are stored in main memory 808 and/or secondary memory 810. Computer programs may also be received via communications interface 824. Such computer programs, when executed, enable computer system 800 to implement embodiments as discussed herein. In particular, the computer programs, when executed, enable processor device 804 to implement the processes of embodiments of the present invention, such as the stages in the methods illustrated by flowcharts 100, 500, and 600 of FIGS. 1, 5, and 6, respectively, discussed above. Accordingly, such computer programs represent controllers of the computer system 800. Where embodiments are implemented using software, the software may be stored in a computer program product and loaded into computer system 800 using removable storage drive 814, interface 820, and hard disk drive 812, or communications interface 824.

Embodiments of the invention also may be directed to computer program products comprising software stored on any computer readable medium. Such software, when executed in one or more data processing device, causes a data processing device(s) to operate as described herein. Embodiments of the invention employ any computer useable or readable medium. Examples of computer readable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nano-technological storage device, etc.), and communication mediums (e.g., wired and wireless communications networks, local area networks, wide area networks, intranets, etc.).

### Conclusion

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of embodiments that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for presenting a plurality of email threads for review, comprising:
analyzing characteristics of an initial email thread to identify a related email thread;
combining the initial email thread and the related email thread to generate a superset thread, wherein the initial email thread and the related email thread are arranged to maintain a context of emails contained in the superset thread; and
displaying the superset thread to a user for review, wherein each unique email in the superset thread is displayed only once.

2. The method of claim 1, further comprising:
comparing the initial email thread and the related email thread to identify duplicate emails.

3. The method of claim 1, further comprising:
suppressing the duplicate emails from one of the initial email thread or the related email thread when duplicate emails are identified.

4. The method of claim 1, wherein analyzing characteristics comprises analyzing header information of one or more emails in the initial email thread.

5. The method of claim 1, wherein analyzing characteristics comprises analyzing prefixes contained in a subject line of one or more emails in the initial email thread,

6. The method of claim 1, wherein analyzing characteristics comprises analyzing texts of one or more emails in the initial email thread.

7. The method of claim 1, wherein analyzing characteristics comprises analyzing attachments of one or more emails in the initial email thread.

8. The method of claim 1, wherein analyzing characteristics of the initial email thread comprises:
analyzing header information of an email in the initial email thread to obtain a message ID of a related email;
identifying a related email thread containing the related email associated with the obtained message ID; and
analyzing header information of remainder emails contained in the identified related email thread to find additional related email threads.

9. The method of claim 1, wherein analyzing characteristics of the initial email thread comprises:
identifying an initial email account associated with the initial email thread;
identifying a representative subject line of emails contained in the initial email thread;
analyzing header information of emails contained in the initial email thread to identify one or more related email accounts distinct from the initial email account; and
searching the identified related email accounts to find related email threads, wherein the identified related email threads contain emails having the representative subject line.

10. The method of claim 1, further comprising:
identifying a connection point email in an email thread to be directly linked to an earliest unique email of another email thread.

11. The method of claim 10, wherein the identifying the connection point email comprises analyzing at least one or more of header information, text body comparison data, and metadata of the earliest unique email in the related email thread.

12. The method of claim 1, further comprising:
receiving at least one or more parameters; and
identifying the initial email and the related email threads based on the one or more parameters.

13. The method of claim 12, wherein the at least one or more parameters includes at least one of account ID, message ID, thread ID, minimum/maximum number of emails in an email thread, date range value, header information of an email initiating an email thread, a list of custodians, a list of accounts, a total number of emails in an email thread, total data size of an email thread, and a plurality of user provided parameters.

14. A method for presenting a plurality of email threads for review, comprising:
analyzing characteristics of an email thread containing a subset of emails;
identifying one or more related email threads each containing a respective subset of emails;
combining the subsets of emails to generate a union set of emails, wherein the union set of emails contains only a single instance of each email in the subsets of emails;
generating a superset thread containing the union set of emails, wherein each email in the superset thread is arranged to maintain a context in relation to each other email in the superset thread; and
displaying the superset thread to a reviewer for review.

15. A system for presenting a plurality of email threads for review, comprising:
a thread analyzer that analyzes characteristics of an initial email thread to identify related email threads;
a database manager that communicates with a plurality of networked databases and identifies email and email thread;
a superset thread generator that combines the initial email thread and the related email threads to identify duplicate emails and generate a superset thread, wherein each combined email thread is arranged to maintain a context in relation to each other email thread in the superset thread.

16. The system of claim 15, further comprising a query parser that parses one or more parameters.

17. The system of claim 16, wherein the one or more parameters includes at least one of account ID; message ID, thread ID, minimum/maximum number of emails in an email thread, date range value, header information of an email initiating an email thread, a list of custodians, a list of accounts, a total number of emails in an email thread, total data size of an email thread, and a plurality of parameters from a review client.

18. The system of claim 15, wherein the thread analyzer comprises at least one of:
a header analyzer that analyzes header information of emails;
a subject line analyzer that analyzes and normalizes a subject line of one or more emails contained in email threads;
a text analyzer that analyzes texts of one or more emails in email threads; and
an attachment analyzer that analyzes attachments of one or more emails contained in email threads.
